(19) United States
(12) Patent Application Publication
(10) Pub. No.: US 2009/0150211 A1
(43) Pub. Date: Jun. 11, 2009

(54) System and Method for Making a Promotional Offer of a Coupon to a Checking Account Customer via an ATM

(76) Inventor: Anthony Jeremiah Bayne, Lomita, CA (US)

Correspondence Address: ANTHONY JEREMIAH BAYNE, 25315 ANDREO AVENUE, LOMITA, CA, 90717, US

(21) Appl. No.: 11/963,762

(22) Filed: Dec. 21, 2007

Related U.S. Application Data
(60) Provisional application No. 61/012,041, filed on Dec. 6, 2007.

(51) Int. Cl. G06Q 30/00; G06Q 40/00

(52) U.S. Cl. 705/10; 705/14

(57) ABSTRACT

Disclosed are methods and systems for offering a coupon to a checking account customer via an ATM. Selecting a coupon to be offered to a checking account customer is based at least in part on information gathered from the customer's cleared checks, so that a coupon offered, is based on a proven sale. A customer may select to have a coupon delivered in paper or digital form by selecting a delivery preference at the ATM.

### RELATED APPLICATION

This application claims priority to provisional patent application 61/012,041 filed on 12-06-2007, and hereby incorporates it by reference, as if fully reinstated herein.

### BACKGROUND OF THE INVENTION

1. Field of Invention

The present invention relates to systems and methods for making a promotional offer via an ATM. More specifically, the invention relates to making a promotional offer of a coupon to a checking account customer at an ATM, when the customer meets advertiser selected criteria.

2. Description of Related Technology

An advertiser may use a coupon to attract a customer to a store or website. A customer may use a coupon at a specific store, or for the purchase of a specific item. Delivering coupons that will be used by the customer remains a challenge to many advertisers.

Paper coupons are a traditional method of attracting new customers, and can be found in printed media, such as newspapers and magazines. Paper coupons are typically related to the subject matter of the printed media in which they are found. For example, a baby food coupon might be placed in a magazine for expectant mothers. Customers having the printed media, find coupons in them that interest them, and then clip them out to make purchases at stores/store websites.

Additionally, a grocery store may sponsor a “customer rewards” (or similar) program that offers coupons to a participating customer. A participating customer will enter a customer identifier during checkout; the identifier is typically the phone number provided by the customer at the time of enrollment in the rewards program. When the cashier prints out a receipt for groceries, coupons are also printed out with the receipt.

A customer who cannot remember his identifier, or is not enrolled in the customer rewards program, may be given a number to enter by the cashier, or by another customer to qualify for a sale price of an item being purchased.

Unlike a personal identification number (PIN) that may be used to access checking account information at an automated teller machine (ATM), persons may be willing to give out a phone number to help a stranger standing with them in a grocery line to qualify for a sale price of an item, because it does not expose assets (i.e. money in a customer's bank account) to risk of theft. This lending/borrowing of an identifier may result in a customer receiving a coupon that might be relevant to the owner of the identifier, but not to the borrowing customer. Therefore remains a need to insure that a promotional offer/coupon is reaching the intended customer, and not merely reaching someone who is using an identifier of a participant. This situation can occur, because there is no requirement that a customer using an identifier submit proof that he is enrolled in the rewards program.

In addition to coupons being placed in magazines and the like, credit card companies often mail coupons to their customer's along with a monthly billing statement. These coupons may reflect customer preferences identified in questionnaires previously submitted by the customer. While a coupon targeting the potential interests of the customer is increased, the customer may not use the coupon, because the customer only likes to shop at a particular store. Therefore, remains a need to provide coupons based on proven, and preferably repeated, sales.

Further, many customers eschew credit cards, and so do not receive coupons associated with credit cards. These customers may be the persons most likely to use coupons in their purchases. Therefore remains a need to provide persons who do not use credit cards, coupons based on proven sales.

Coupons in “virtual”, “digital”, or “paperless” form, may be delivered to a customer's mobile phone, through a mobile network via a short message service (SMS) text message by a mobile coupon provider such as “Cellfire, Inc.”. A customer can redeem such a coupon at a merchant's store, without the necessity of printing out the coupon, by presenting a bar code on the customer's mobile phone screen to be scanned by a cashier, or presenting an alphanumeric code to a cashier for entry at the point of sale (hereinafter “POS”). At the time of this writing, most mobile advertising coupons are for small dollar items (e.g. pizzas, and other food items). Therefore, remains a need to attract advertisers to use paperless coupons for bigger ticket items (e.g. home repair, living room furniture, etc.).

Mankoff (U.S. Publication No. 20050071230) uses the location of an ATM, or the customer's mobile phone, to detect where the customer is located, to offer coupons that the customer may use at a nearby store. However this method does not rely on proven sales to offer a coupon. Therefore remains a need to present coupons that have a greater likelihood of being used by a customer.

### BRIEF SUMMARY OF THE INVENTION

The present invention solves the above described problems and provides a distinct advantage in offering and providing coupons of interest to a customer. The embodiments described in this application teach selecting a coupon to offer to a checking account customer, based on the buying habits of the customer (as evidenced by information stored in a customer checking account database, including payee data, memo field information, etc.) when the customer accesses an ATM.

People usually keep their PINs secret. A checking account customer must have a PIN and access card to access a bank account via an ATM. Since the PIN must be used with the associated access card to access a customer's account and obtain cash, it is likely that only the customer whose account it is will receive a promotional offer when a customer accesses a bank account via an ATM. This is to be contrasted to a grocery rewards program participant who receives coupons when they merely provide an identifier of someone who is enrolled in a rewards program.

The customer may select a coupon presented at the ATM, and the delivery method of the same. Coupons may be freely transferable, and have expiration dates. Paperless redemption at the POS is also enabled by embodiments disclosed in this application.

To use the described approaches, a checking account customer “opts in” to a coupon program that may be bank sponsored. A bank sponsored program may charge advertisers for making promotional offers to customers, as well as customers. Alternatively, the service may be free to customers. A customer may affirmatively “opt in” by filling out and returning a signed authorization form sent by the bank to the customer, enrolling at a bank website, or by not “opting out”, if the bank sends out new “terms and conditions of service” that advises the customer that they will automatically be enrolled in such a program unless they affirmatively “opt out” in writing. Further, a bank may allow a third party to solicit enrollment of bank customers in the program.

A customer, who opts in to a bank's coupon program, agrees that the bank may determine, one or more factors relating to the customer's cleared checks or checking account transactions. These factors may include at least the identity of a payee, the date a check was written, tendered, or paid (e.g. in the 30 days preceding the time of accessing the ATM), the dollar amount of a check, the aggregate amount of two or more checks, the average amount of two or more checks, how frequently the customer accesses an ATM, the frequency the customer has written a check to the same payee over a specified time period, and a description of a product or service noted in the “memo” or “memorandum” field of a check (e.g. “new roof”). Further, the customer may agree that the bank be allowed to categorize the customer by an age range, based on information provided by the customer in any application submitted by the customer, or gathered from a public source, for the purpose of offering promotions to the customer. The bank determines one or more of the abovementioned factors for each participating checking account customer.

In a preferred embodiment, the checks are scanned into a searchable customer checking account database, where the factors for each customer can be searched and categorized by a search engine used by a bank system administrator. Alternatively, a human could read a participating customer's check and manually enter factors from each check into a searchable database.

The identity of the checking account customer, and other personal identifying information (e.g. address) of the customer known to the bank, or viewable on the face of a cashed check, (e.g. such as a customer's driver's license number written on a check by a cashier) is preferably not shared with, or made accessible to a third party. However, the bank using the customer's checking account application, or other customer provided information, may provide an age range of ages (e.g. 18-20, 21-25, etc.) as an additional criteria/category for an advertiser to select from, though this information is typically not included on a check.

A bank may create an information retrieval system, that includes a searchable customer checking account database to store information taken from a customer's cashed check, as well as a search engine to find and match that information to an advertiser's criteria, stored in an searchable advertisement database, to present a promotional offer (i.e. one or more coupons) to a customer who has evidenced that he/she buys at a particular store, within a given period of time, and has spent over a threshold amount. In this way, the bank will provide value to both the advertiser and the customer.

Criteria relating to the bank's checking account customers may be offered to an advertiser to select from. An advertiser may establish and modify the minimum criteria for qualifying a checking account customer to receive a coupon offer by way of a bank website. Criteria can be individual search terms, or terms that are part of a category. Categories may include “standard categories” (e.g. “household goods”), and “premium categories” (e.g. “payee name”) of information, or a combination thereof (e.g. “Household goods+Macy's”). Alternatively, instead of, or in addition to products/services/payee categories, a premium category may consist of single big purchase transactions (e.g. a transaction over $200.00). Instead of using a “payee name”, a standard industry code (SIC) could be used. Additionally, a bank may advise an advertiser of the approximate number of client's that meet an advertiser's criteria for each category selected. In this way a bank could offer a “standard” and “premium” advertising service, as well as give the advertiser an approximation of how may presentations may be made. An advertiser, by selecting criteria based on one or more of the above factors will be able to offer targeted advertising based on proven sales.

In embodiments described herein, systems and methods are provided for qualifying, offering and delivering a coupon (paper/paperless) to a customer. Embodiments described in this application accordingly provide for the delivery of paperless coupons to a customer's mobile phone, or other similar wireless device, that may be enabled to receive and transmit near field radio transmissions, or SMS-text messages

In embodiments described herein, the advertiser will be able to select the minimum qualifying criteria for a checking account customer to receive a promotional offer. The bank will determine whether a customer meets the advertiser's criteria, and present an offer for one or more coupons to the customer when the customer meets the criteria and accesses an ATM. In a preferred embodiment, a determination is made of whether the customer qualifies to receive a promotional offer, regardless of enrollment status, so as to be able to offer enrollment if the customer qualifies to receive an immediate benefit and is not enrolled. In a further preferred embodiment, a promotional offer will be made after the customer has completed a selected ATM transaction. However, a coupon offer can be made to a customer at any time the bank chooses, as long as the customer meets an advertiser's minimum qualifying criteria for presentation. In this way an advertisement is not “pushed” by the advertiser or bank. In some embodiments, once a customer has demonstrated no interest in the bank's promotional offers for coupons, no similar offer will be made via an ATM for a period of time (e.g. 30 days), so as not to annoy the customer. Alternatively, the customer may choose to never again receive such an offer at an ATM.

Promotional offers are described herein in embodiments relating to “money-off” coupons the purchase of goods or services. “Advertiser” as used in this application includes product manufacturers, merchants, and other companies or entities desiring to entice persons to use a coupon for their products or services by way of a promotional offer.

In one embodiment, the invention provides for a method to qualify a checking account customer to receive a promotional offer at an ATM, when the customer meets an advertiser's selected criteria.

In another embodiment, the invention provides for a system to qualify a checking account customer to receive a promotional offer at an ATM, when the customer meets an advertiser's selected criteria.

In another embodiment, the invention provides for a system configured to present a promotional offer to a customer at an ATM when a processor matches criteria from an advertiser to customer checking account data.

The above summary has outlined the embodiments described in this application, but should be used in the context of the entire specification to illustrate some of the features of these embodiments. Accordingly, other features and a fuller understanding of these embodiments may be had by referring to the entire specification.

### BRIEF DESCRIPTION OF THE DRAWINGS

FIG. 1 is a block diagram illustrating an exemplary system in accordance with certain embodiments of the present invention; and

FIG. 2 is a schematic flow diagram of the qualifying, offering and delivery of a coupon to a checking account customer at an ATM.

### DETAILED DESCRIPTION OF THE EMBODIMENTS

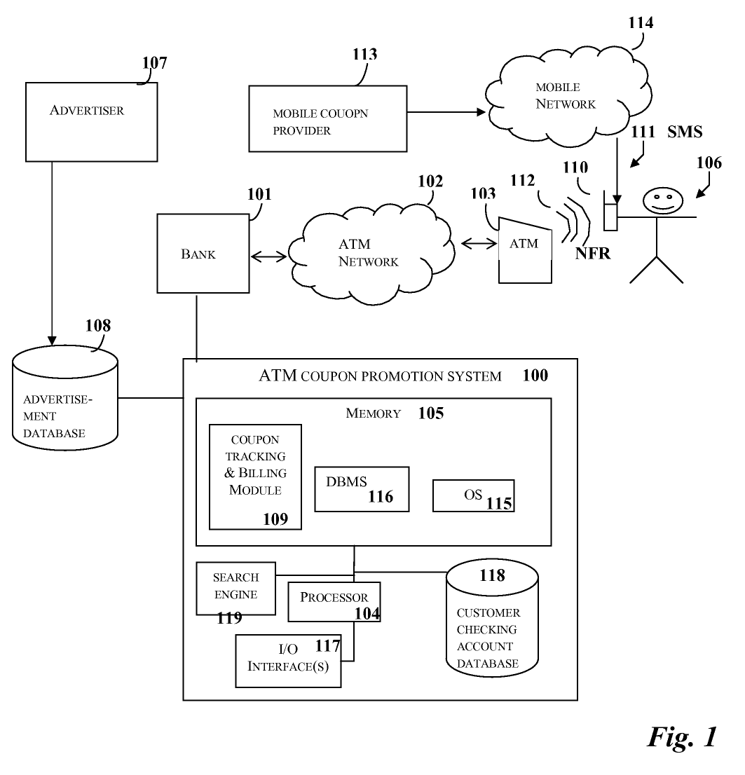

Exemplary embodiments of the present invention will hereinafter be described with references to the figures, in which like numerals indicate elements throughout the several drawings. FIG. 1 is a block diagram illustrating an exemplary operating environment for implementation of certain embodiments of the present invention. The exemplary operating environment includes an ATM coupon promotional system (ACPS) 100 of the present invention. The ACPS 100 is linked to at least one bank 101, that is connected via an ATM network 102 to at least one ATM 103, The ACPS 100 may be hosted by the bank 101, or another financial institution (not shown).

The ACPS 100 has a processor 104 and a memory 105 for storing data coupled to the processor 104. The processor 104 is configured to determine whether a customer 106 qualifies to receive a promotional offer, based on advertiser 107 selected criteria stored in an advertisement database 108, to receive promotional coupon offers when the customer 106 accesses an ATM 103.

The ACPS 100 is contemplated as being a processor 104 driven device or collection of devices, that is configured for qualifying, offering and presenting promotional coupon offers. The ACPS 100 may further be configured for accessing and reading associated computer readable media having stored thereon data/and or computer executable instructions for implementing the various methods of the present invention. In particular the processor 104 provides the business logic for the ACPS 100 that supports and provides an environment for server side logic, expressed as objects, rules and computations, such as determining whether a customer qualifies to receive a coupon.

The ACPS 100 includes a memory 105, which may take the form of any computable readable medium. The memory 105 may be logically and/or physically divided into multiple units. The memory 105 stores data and program modules, such as, for example, an operating system (“OS”) 115, a database management system (“DBMS”) 116. These and/or other programs may be executed by the ACPS 100 to perform the various methods of the present invention.

The ACPS 100 may include, or be in communication with, one or more searchable databases. By way of illustration only, the ACPS 100 may be in communication with a searchable advertisement database 108. These and/or other databases may also store any other data used or generated by the ACPS 100. Those skilled in the art will appreciate that the illustrated database may be physically and/or logically separate from one another.

The ACPS 100 may also include input/output (“P/O”) interfaces 117 for providing logical connections to various I/O devices, such as a scanner, a mouse, etc. A system administrator may utilize these and other I/O devices to interact with the ACPS 100. For example, a system administrator may interact with the ACPS 100 to populate and edit the customer checking account database 118, and other program modules, etc. In a preferred embodiment the customer account database 118 will be searchable by a system administrator using a bank search engine 119. Those skilled in the art will appreciate that the ACPS 100 may include alternate and/or additional components, hardware or software.

Thus configured or similarly configured, the ACPS 100 may provide promotional offers, including coupons, to a qualifying checking account customer 106, via an ATM 103, when the ACPS 100 is programmed to interact with a customer 106 using the ATM 103.

The advertisement database 108 may be accessed directly by an advertiser 107 via a website (not shown), so that an advertiser 107 can enroll in the bank's 101 ATM advertising program, select qualifying criteria for whom may receive advertiser 107 promotional coupon offers, and manage an advertising campaign. Enrolling in, and managing an advertising program is well know to those skilled in the art (e.g. Google's Adwords®), and so not discussed in further detail herein. Additionally the advertisement database 108 may be accessed by the ACPS 100 to check for updated advertiser 107 criteria and promotional offers. Further, the ACPS's 100 coupon tracking and billing module 109 may update the advertisement database 108 so that an advertiser 107 can check how many coupons, what coupons, and from what ATM 103 location, have been distributed. Equipped with these metrics, an advertiser 107 can evaluate the effectiveness of an ATM advertising campaign, and make adjustments to criteria as desired.

Coupons are offered via an ATM 103, but the customer 106 may be given delivery options for their delivery. For example, a customer 106 may select to have a paper coupon (not shown) printed out of the same aperture that the ATM 103 uses to printout transaction slips, by using the same slips of paper that banking transactions are printed on, so as to eliminate the necessity of any clipping any coupons by the customer 106.

In yet an another embodiment, the customer may select a paperless/virtual coupon be sent to the customer's 106 mobile phone 110 via a text message 111, or by a mobile coupon provider 113 having an agreement with the bank 101 to do so. A coupon may be sent to a phone number associated with the customer 106 stored in the customer checking account database 118, or the ATM 103 may prompt the customer 106 to use the ATM's 103 numeric keypad (not shown) to input a mobile phone 110 number. Such text message 111 may consist of an alpha-numeric code that a cashier at an advertiser 107 POS can enter manually, or other cashier recognizable scan able image (e.g. text barcode) that can be presented on a mobile phone 110 screen that can be used by the customer 106 to receive a discount. Alternatively, if the mobile phone 110 and ATM 103 are so equipped, a customer may have a coupon transmitted to his mobile phone 110 by near field radio (NFR) transmission 112. A coupon thus delivered, may be electronically transmitted from the customer's mobile phone 110 to the merchant POS terminal (not shown) or other equipment, at the advertiser's POS. Redeeming coupons is well know to those skilled in the art, and so not discussed in further detail herein.

The bank 101 may have an arrangement with a mobile coupon provider 113 (e.g. “Cellfire”) to deliver coupons via a mobile network 114 to bank 101 customers 106. In a preferred embodiment, using a mobile coupon provider 113 to deliver a coupon, the bank 101 will transmit a phone number and a coupon identity number associated with a coupon in the advertisement database 108, to the mobile coupon provider 113 to deliver to the customer 106. The mobile coupon provider 113 may access the advertisement database 108 (via the ATM network 102, or other wired or wireless network, not shown) to extract the coupon identified. In this way, the bank 101 does not disclose the financial information of the customer 106. This may deter a mobile coupon provider 113 employee from developing a targeted mobile advertising campaign using customer 106 banking information.

To redeem a coupon, the customer 106 visits the advertiser's 107 physical or online store (not shown). In an online redemption, the customer 106 redeems a coupon by entering a promotional code found on the coupon into an appropriate field when prompted to do so. Redemption of a coupon online is well know by those skilled in the art, and so is not discussed in further detail herein.

“Coupons,” “coupon offers,” and “promotional offers” should be broadly construed to include items that are redeemable or otherwise have value, such as frequent flyer miles, “points”, “tickets”, or “credits” that may be redeemable for reward goods and/or services. Likewise “bank” 106 refers to any financial institution that offers a customer 106 ATM 103 access to the customer's account. Likewise, while the invention contemplates using traditional paper checks that have cleared, it should be appreciated that information related to a customer's purchases using a “check debit card” could likewise be used to acquire much of the same data gathered from a traditional paper check.

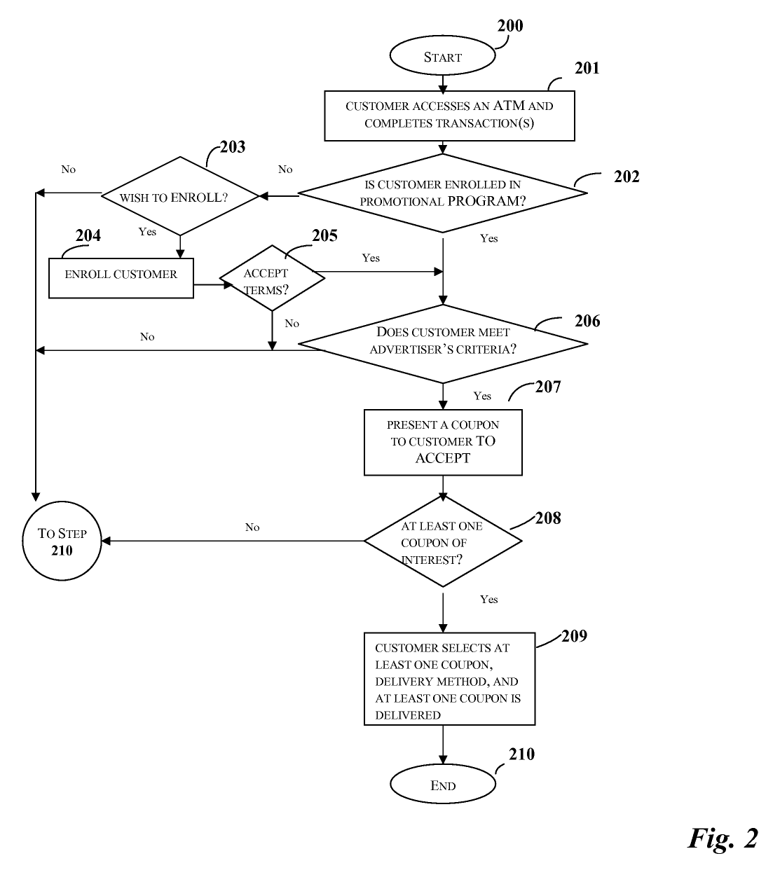

FIG. 2 illustrates, in accordance with an exemplary embodiment of the present invention, the qualifying of a checking account customer 106 to receive an offer for a promotional coupon offer, and delivery of a coupon to the customer 106. The process starts at step 200, and proceeds to step 201 when a checking account customer 106 accesses an ATM 103, connected to a bank 101 offering advertiser 107 sponsored promotions. In a preferred embodiment, the customer 106 completes all financial transactions at the ATM 103 before the method presents any promotion to a customer 106.

After the customer 106 completes his/her transactions, the method proceeds to step 202 where it is determined if the customer 106 is enrolled in the bank 101 sponsored promotional program. This is accomplished, for instance, by querying the customer checking account database 118, to see if the customer 106 is enrolled. If the customer 106 is enrolled, the method proceeds to step 206 (discussed infra).

If the customer 106 is not enrolled, the method proceeds to step 203 where the method queries the customer 106, by way of graphical user interface (e.g. ATM screen), or audibly by way of an ATM 103 equipped with a speaker/ear jack (not shown), if the customer 106 wishes to enroll in the bank 101 promotional program by (for example) choosing a “yes” or “no” display button.

If the customer does not respond within a specified time parameter, or makes a selection other than “yes”, the method proceeds to step 210, and ends. If the customer 106 selects “yes”, or provides some other affirmative response to indicate the customer 106 wishes to enroll the in the bank's 101 promotional program, the method proceeds to step 204, where the method may present terms and conditions (not shown) to the customer 106 to accept before enrolling the customer 106.

The method then proceeds to step 205 where it is determined if the customer 106 accepts the terms and conditions for enrollment. If the customer 106 does not accept, by selecting “yes”, re-entering the customer 106 PIN code, etc., the method proceeds to step 210 and ends.

If the customer 106 accepts the presented terms and conditions, the method proceeds to step 206 where it is determined if the customer 106 meets an advertiser's 107 minimum qualifying criteria for the presentation of a promotional coupon offer. For example, the processor 104 may match advertiser 107 criteria to a customer's 106 cleared check information, stored in the customer checking account database 118, to determine if the customer 106 qualifies to receive at least one promotion from at least one advertiser 107, based on advertiser 107 criteria.

If the customer 106 does not meet the criteria of at least one advertiser 107, no promotional offer is made to the customer 106, and the method proceeds to step 210 and ends. If the customer 106 criteria meets the presentation criteria of at least one advertiser 107, the method proceeds to step 207 where a promotional presentation of at least one coupon is made to the customer 106 via the ATM 103 graphic user interface (not shown), or audibly by a speaker/phone jack (not shown) on the ATM 103.

The method then proceeds to step 208, where it is determined if the customer 106 is interested in receiving at least one coupon presented. If the customer does not select at least one coupon, or does not respond to the promotional offer, or otherwise communicates no interest in the promotion (e.g. by selecting a “return card”, “end session”, “exit” or similar command) the method proceeds to step 210 and ends.

If the customer 106 indicates an interest in at least one coupon presented the method proceeds to step 209, where the customer 106 selects a delivery method of the at least one coupon. The customer may select a paper coupon that may be printed out from the ATM 103, or delivered to the customer's 106 mobile phone 110 (or other wireless device) via an SMS-text message 111, or NFR 112 transmission.

It should be appreciated that the exemplary aspects and features of the present invention, as described above are not intended to be interpreted as required or essential elements of the invention, unless explicitly stated as such. It should also be appreciated that the foregoing description of exemplary embodiments was provided by way of illustration only, and that many other modifications, features, embodiments and operating environments are possible. Accordingly, the scope of present invention should be limited only by the claims that follow.

I claim:

1. A method of making a promotional offer to a checking account customer via an ATM, comprising:
receiving criteria for presenting a promotional offer via an ATM;
accessing an ATM by a checking account customer;
determining whether the customer meets the criteria to present a promotional offer, when the customer accesses the ATM;
presenting a promotional offer to the customer via the ATM, when the customer meets the criteria; and
distributing the promotional offer to the customer, when the customer accepts the promotional offer.

2. The method of claim 1, wherein the determining whether the customer meets the criteria to present a promotional offer, is determined by matching information stored in a searchable advertisement database to information stored in a searchable customer checking account database.

3. The method of claim 1, wherein the promotional offer is a coupon for an advertiser's good or service.

4. The method of claim 3, wherein the coupon comprises a group consisting of a paper coupon and a digital coupon.

5. The method of claim 4, wherein the digital coupon further comprises a format that can be recognized by a merchant, or scanned at a merchant's point of sale.

6. The method of claim 4, wherein the paper coupon is transferable.

7. The method of claim 4, wherein the paper coupon is non-transferable.

8. The method of claim 1, wherein the criteria includes a group of factors consisting of a threshold dollar amount, a date a check was written, a date a check was tendered for payment, a date a check was paid, a name of a payee, a location of a payee, a standard industry code of a payee, the frequency a checking account customer accesses an ATM, the frequency a customer has written a check to the same payee during a period of time, and a description of a product or service in a memo field of a check.

9. The method of claim 8, wherein the threshold dollar amount further comprises a group consisting of a dollar amount of a check, an aggregate dollar amount of two or more checks, and an average dollar amount of two or more checks.

10. The method of claim 8, wherein a date a check was written, a date a check was tendered for payment, and a date a check was paid, further comprises a look back period from the time the ATM is accessed by the customer

11. The method of claim 1, wherein distributing the promotional offer to a customer includes a group, consisting of printing out a paper coupon from the ATM, transmitting the coupon via near field radio transmission, and sending a SMS text message to a customer's mobile device.

12. The method of claim 11, further comprising the customer entering a mobile phone number via an ATM keypad, when choosing to receive the promotional offer by SMS text message.

13. The method of claim 3, wherein the value of a coupon diminishes with time.

14. The method of claim 13, wherein the value diminishes with time relative to the time the coupon was distributed.

15. The method of claim 8, wherein the criteria consists of a standard category, and a premium category.

16. A system for making a promotional offer to a checking account customer via an ATM, comprising:
means to access a searchable advertisement database having criteria for making a promotional offer;
means to access a searchable checking account database having information regarding a checking account customer's checking transactions;
means to access an ATM by a checking account customer;
means to determine whether the customer meets the criteria to receive a promotional offer via the ATM, when the customer accesses the ATM;
means for presenting the promotional offer to the customer via the ATM, when the customer meets the criteria; and
means for distributing the promotional offer to the customer, when the customer chooses to accept the promotional offer.

17. A computer-readable medium having stored thereon computer executable instructions for performing the system of claim 16.

18. The system of claim 16, wherein the means to determine whether the customer meets criteria to present a promotional offer, is determined by matching criteria in the searchable advertisement database to information stored in a searchable checking account database.

19. A system comprising:
a processor;
a memory for storing data coupled to the processor, wherein the data further comprises customer checking account data and advertiser criteria data;
wherein the customer checking account data comprises a group consisting of a customer name, a dollar amount, a payee name, a date, and a word in a check memorandum field; and
wherein the processor is configured for comparing advertiser criteria to customer checking account data, and outputting a promotional offer at an ATM accessed by a customer when a match of the advertiser criteria and customer checking account data occurs.

20. The system of claim 19, further comprising a mobile coupon provider transmitting a digital coupon to the checking account customer, wherein the digital coupon is identified to the mobile coupon provider by an identifying number.
